(19) United States
(12) Patent Application Publication
(10) Pub. No.: US 2004/0040640 A1
(43) Pub. Date: Mar. 4, 2004

(54) Method for making an article and a textile laminate therefor

(76) Inventor: Y. A. Bordes, Paris (FR)

Correspondence Address: Dickstein Shapiro, Morin & Oshinsky, 41st Floor, 1177 Avenue of the Americas, New York, NY, 10036-2714, US

(21) Appl. No.: 10/381,035

(22) PCT Filed: Sep. 24, 2001
(86) PCT No.: PCT/GB01/04237

(30) Foreign Application Priority Data
Sep. 22, 2000 (GB) 0023321.3

(51) Int. Cl. B32B 31/00; B65C 1/00; B29C 65/06

(52) U.S. Cl. 156/73.5; 156/299

(57) ABSTRACT

A knitted terry-cloth elastic base fabric (4) is used to make a laminate (2), the base fabric (4) having a cotton pile (8) and an elastic support (6) made of two different synthetic yarns. Two layers (16, 18) of polyurethane resin are deposited on an anti-stick support web and set to form a skin, and a layer (14) of polyurethane resin having adhesive properties is deposited on the skin layer (18). The base fabric (4) is applied to the adhesive layer (14) whilst the latter is still liquid, after which the adhesive layer (14) is set. Finally, the skin (16, 18) is detached from the support web. The layers of polyurethane resin are substantially impermeable to water and permeable to water vapour. Pieces of the laminate are joined together by ultrasonic welding to melt and re-set the respective skin (16, 18) and adhesive to (14) form a water-tight join and form a made-up article. During the welding, at least one yarn of the base fabric (4) does not melt.

### BACKGROUND TO THE INVENTION

The present invention relates primarily to a process for making an article by making joins between pieces of (textile) fabric. The process can comprise laminating a plastics film or skin to a base fabric to form the fabric.

The object of the invention is primarily that of providing a process for making an article using a laminate which stretches and can be formed into three dimensional shapes and which is impermeable to water and permeable to water vapour.

It is also an object of the present invention to overcome or ameliorate at least one of the disadvantages of the prior art, or to provide a useful alternative.

JP 63-116 849 A discloses using a polyurethane-based adhesive to laminate a polyurethane skin to a base fabric in order to produce a waterproof cloth having a high moisture permeability, which is attributed to the presence of a plasticiser in the polyurethane adhesive. Although the base fabric can be woven, knitted or non-woven, it is not a stretch fabric as normally understood.

### THE INVENTION

The present invention provides a process as set forth in claims 1, 6, 51, 53 or 54, a laminate as set forth in claims 50 or 52 and a made-up article as set forth in claims 49 or 55. The remaining claims set forth preferred or optional features of the invention.

Some substances have precise melting points and others melt over a range of temperatures. The term “melt” as used herein means that the substance has become sufficiently liquid to form a stable weld when it has cooled and re-set.

As indicated below, the base fabric preferably has a pile on one side. In the following description, when the laminate is referred to, the “skin side” and the “pile side” are used to denote the opposite sides of the laminate. When the base fabric is referred to, the “smooth side” and the “pile side” are used to denote the opposite sides of the base fabric. The pile will be incorporated in the base fabric, but the part of the base fabric that is not formed by the pile yarn is termed the “support”; another term is “ground construction”. If the skin is in two (or more) layers, the outer layer is that further from the base fabric.

The laminate does not absorb water on the skin side and is substantially impermeable to water, but permeable to water vapour.

The Base Fabric

The base fabric preferably has a pile on one side, preferably a closed-loop pile, e.g. a terry-cloth or the like. The laminate obtained in this way is fairly open so that it has an excellent permeability to air and to water vapour and can absorb moisture on the pile side. The use of a closed-loop pile offers amongst others the advantage that the laminate can be used to make close-fitting clothing, for example tracksuits with the closed-loop pile in contact with the skin so as to act as a layer for absorbing sweat. Furthermore, the pile provides for a certain amount of air circulation within the base fabric whilst the air acts as a temperature barrier, and the pile can assist the stretch.

Preferably, the base fabric is knitted, and it can be made on a circular knitting machine with multiple picks.

The elastic base fabric, together with the stretchable adhesive and the stretchable skin, make the laminate elastically stretchable in two directions at right angles in the plane of the base fabric, for instance to adapt the laminate to the shape of the body in the case of a garment or to adapt it to the shape of a e.g. chair in the case of a furniture cover; in the made-up article, the laminate will be stretchable in three directions at right angles. The base fabric, and the laminate, can preferably stretch by more than about 100%, though other minima are about 50% and about 30%. By “elastic” is meant that on release of tension, the laminate returns substantially to its original unstretched configuration. Nonetheless the laminate can be hot washed (e.g. subjected to an industrial washing cycle at up to 90° C.) or ironed with a Teflon iron or a steam iron.

The base fabric (or its support if there is a pile) is elastic, and can be made of at least two types of yarn, one at least of which is elastic; the other yarn is preferably substantially inextensible, which can reduce costs and also can prevent the fabric deforming on returning from a stretched configuration. The yarns can be made of an inherently elastic material, or can be spun to provide elasticity. Preferably both yarns are synthetic, such as a polyester for a first yarn (which can be effectively inelastic) and an elastic resin such as polyurethane or nylon for a second, elastic yarn; the elastic yarn may be a composite yarn such as “Elastane”, “Spandex” or “Lycra”, having an elastic core with a further yarn such as polyester wrapped around it. However, if appropriate, one of the yarns could be natural.

For welding, at least one yarn of the base fabric may melt and re-set during the welding procedure, and this will be a yarn of the support if there is a pile. More generally, it is preferred that the support comprises two different yarns; in this case only one yarn or neither yarn may melt during the welding procedure. It is highly desirable that the base fabric comprises at least one yarn which does not melt (or degrade) during the welding procedure. The yarn or yarns of the base fabric which remain unmelted during the welding procedure maintain the strength of the base fabric.

The yarn for the pile may be for instance any natural yarn, though cotton is the preferred material—the yarn can be merely cotton-containing or contain more than about 80% cotton or be substantially pure cotton. If cotton is used for the pile, the base fabric may have in total about 92% cotton and about 8% resin, by weight (in the laminate there may be about 82% cotton, by weight). Nonetheless, other yarns such as wool, silk or linen are possible, as well as any suitable synthetic yarn which preferably does not melt or degrade or become damaged at the welding temperature.

Preferably the base fabric has a weight (before lamination) of less than about 350 g/m², preferably in the range of about 250 to about 320 g/m², lower weights being preferred. If the pile is cotton-containing, the support of the base fabric preferably has a thickness less than about 0.4 mm, for instance of about 0.3 mm, and a pile height less than about 2.5 mm, preferably about 1 to about 2 mm. If say wool is used for the pile, the weight and thickness of the base fabric may be different.

Preliminary Treatment for Finishing the Base Fabric

The unfinished base fabric, after being for instance cut length wise and opened up, can be subjected to various finishing treatments in a roller mill, such as blank sizing, amongst other things to make it anti-static, or to dyeing, followed by drying in a tumbler and then trimming.

The Skin

The skin is destined to form the outside layer of the laminate and is preferably formed of one or more layers of polyurethane resin, though for instance another resin may be used. The preferred polyurethane resin or resins is or are aromatic one-component polyurethanes, which resist both light and alcohols, preferably with no plasticisers. The polyurethanes can be initially in solution in alcohol (e.g. ethanol or propanol) and/or in toluene and/or dimethyl formamide, and then set. It is found that using two layers can increase the strength of the weld.

The skin can be formed in any suitable way, for instance by extrusion, but in one process, it is formed by depositing a liquid layer of resin on a non-stick support and setting the resin. By setting is meant any setting procedure, whether or not the resin is fully hard, which can be evaporation of a solvent and/or a chemical change such as curing, chain extension or polymerisation, whether of a one-component resin or of a two or more component resin.

The skin is preferably formed in at least two layers of different composition. The outer layer is preferably not hydrophilic whilst the inner layer is preferably hydrophilic, or vice versa The outer layer may have a higher melting point than the inner layer, or vice versa, or the melting points may be substantially the same. Although early experimental work was done on a two-layer skin with the outer skin layer having a higher melting point than the inner skin layer, it is now believed possible that welding is improved if the outer skin layer has a lower melting point than the inner skin layer, or substantially the same melting point as the inner skin layer; further improvement may be possible if the outer skin layer has a lower melting point than the adhesive and/or a lower melting point than any yarn of the base fabric. In a preferred procedure, the second layer, which may be the inner layer, is deposited as a liquid on the first layer. In this case, the first layer is preferably not fully hard and it is possible though unlikely that the second layer may penetrate or soak to a greater or lesser degree into the first layer. It is found that the incorporation of the second layer increases the strength of the weld. It can also make the skin smoother, eliminate stickiness and make the laminate itself stronger.

The outer layer (or the single layer) of the skin melts and re-sets during the welding procedure. Though not essential in all circumstances, it is preferred that all of the skin should melt (and re-set) during the welding procedure.

A plasticiser can be added to the skin, or to one or both layers of the skin, but is not preferred.

The Adhesive

The adhesive is preferably formed of a polyurethane resin, though for instance another resin could be used. The resin is preferably hydrophilic. A plasticiser can be added, but is not preferred. The preferred polyurethane resin is an aromatic one-component polyurethane, though it is alternatively possible to use or include multi-component resins, formed of two or more different polyurethane resins bound by linking agents. The linking agents preferably used for such resins have an isocyanic (aliphatic) or melamine (cyclic) or aromatic structure (to provide isocyanic, melamine or aromatic curing). Thus the adhesive can comprise a urethane precursor and a melamine precursor, and in general the adhesive can comprise a mixture of resins. The polyurethane or other resin adhesive, although passing into and providing a very firm anchorage to the support of the base fabric, does not pass right through the base fabric and does not alter the properties of the pile of the base fabric, which in this way, maintains its softness and absorbing properties. For application, the resin can be dissolved in any suitable solvent, such as dimethyl formamide. Though not essential in all circumstances, it is preferred that the adhesive should melt (and re-set) during the welding procedure.

Skin and Adhesive (the Coating)

The skin and the adhesive (the coating) may together, when set, have a thickness of about 15 to about 20 microns.

The skin and the adhesive are preferably transparent and colourless. In this way, the structure and colour and any decoration on the smooth side of the base fabric remain clearly visible through the adhesive and the skin. Thus the base fabric can be dyed or can be subjected to a decorative printing operation, in particular if the laminate is for clothing or furniture covers. Alternatively however, it is possible to print on the skin, or the skin can be dyed or embossed, e.g. so that it looks like fur.

The Laminate

In general terms, the laminate is substantially impermeable to water but permeable to water vapour. To a certain extent, the greater the impermeability to water, the less the permeability to water vapour and also the less strong the skin of the laminate. The precise permeability to water and permeability to water vapour can be chosen according to the use required of the made-up article. A standard test for permeability to water is ASTM E96-95, procedure E, giving the height of the water column required for water to penetetrate the laminate. The column height is preferably at least about 500 or about 1000 mm, and can reach 2000 or even 5000 mm. A first test for permeability to water vapour, also known as transpirability or breathability, is ASTM E96-80, in which the permeability to water vapour is expressed in g/m2 passing through the test piece in 24 hours. A value of about 600 or about 700 is around the minimum for effective permeability to water vapour, though this depends on the use of the laminate, a greater value, say of a minimum of about 1000 or about 1250 or even about 1500 being desirable for a garment. A second test is BS EN 31092, in which the permeability to water vapour is expressed as an RET value. An RET value of zero means infinite transpirability and an RET value of 200 means effectively no transpirability. The laminate preferably has an RET value less than at least about 120 or about 80, and RET values of about 56 can be achieved though values as high as about 170 or about 190 are acceptable. If the laminate has a good transpirability and is being used as a garment, the wearer has a good sensation of comfort.

In a first test, the laminate was as follows:

Single skin layer—“VITHANE TR 7030”, as at Apr. 1, 2001;

Adhesive—“VITHANE TR 7050”, as at Jul. 1, 2001.

The test results were:

ASTM E96-95—2000 mm;

ASTM E96-80—3850 g/m²/24 hours (at 37° C.)

In a second test, the laminate was as follows:

Outer skin layer—about 35 g/m² “Sofinal”, an aromatic one-component polyurethane as at Jul. 1, 2001 (a resin supplied by the Sofitex Group, and similar to “VITHANE 319” described below, but somewhat hydrophilic;

Inner skin layer—about 25 g/m² “VITHANE TR 7030”, as at Jul. 1, 2001;

Adhesive—about 30 g/m² “VITHANE TR 7050”, as at Jul. 1, 2001.

Total weight of coating—93 g/m²

Weight of fabric—304 g/m²

The test results were:

ASTM E96-95—5000 mm (at 22° C.);

ASTM E96-80—1492 g/m²/24 hours (at 22° C.);

BS EN 31092—163 m².mbar/W (at 22° C).

In a further test on a different laminate according to the invention, the test results were:

ASTM E96-95—2000 mm;

ASTM E96-80—2800 g/m²/24 hours

In order to make the laminate permeable to water vapour as well as being impermeable to water, transpiring hydrophilic polyurethanes can be used for both the skin (one or both layers, if there are two layers) and the adhesive, that is having a molecular structure which, by its nature, absorbs water vapour, releasing it then to the external ambient. These may be in particular aromatic polyurethanes.

Making the Laminate

The adhesive can be applied as a liquid layer to the skin, and the base fabric can be applied to the adhesive-coated skin, the adhesive subsequently being set. However, as an alternative, the adhesive can first be applied to the base fabric, for instance with two or three coating rolls, and the skin pressed onto the adhesive-coated base fabric.

Use for Laminates

The laminates obtained according to the invention can be used, for example, for the following applications:

clothing, e.g. sports clothing, or protective clothing for instance for medical or paramedical use, or fashion garments;

furniture covers;

coverings for vehicle seats;

hospital, hotel and similar “linen”;

gloves, stockings and socks;

cushion and pillow covers.

Making up Articles

The laminates are very suitable for morpho-cutting, i.e. cutting to provide pieces which are correctly shaped for joining together to conform to the shape of e.g. the body. It is known to join such pieces by stitching, taping or glueing. According to the invention, excellent joins are made between the various portions of the laminate by welding, preferably by ultrasonic welding. Ultrasonic welding has been found particularly suitable for the laminates of the invention, which normally comprise layers and yarns of differing melting points. If carried out in a proper manner, the temperatures achievable are not sufficiently high to degrade or even melt the yarns or some of the yarns. It is believed that during the welding, the skin (both layers if present), the adhesive, and possibly at least one of the yarns of the support of the base fabric melt, and subsequently re-set. As explained above, preferably at least one of the yarns of the support does not melt (or degrade), and the pile preferably does not melt (or degrade). The joins are waterproof and no subsequent waterproofing is required; there is no need for time-consuming operations such as glueing on tapes. Special block points (stronger joins) can be put in to prevent rupture under load of the ends of the joins or as a special design feature, or merely to tack the portions of the laminate together before seam welding.

In order to weld, the portions of the laminate can be placed face-to-face with the respective skins in contact, either by taking separate pieces or by folding a single piece; the skin and the adhesive of the respective portions are melted. This will leave a stand-up seam, which is acceptable for instance for protective clothing, but for garments for instance, joins looking like butt-type joins (edge-on-edge) can be formed and the made-up article can appear to be practically seamless or alternatively the joins can be utilised as a fashion decoration. To achieve the quasi butt-type joins, substantially all of the edge zones are trimmed away, and the welding and cutting can be done in one operation or simultaneous. The join can be improved by using a pressure wheel to press the portions together in the welding zone.

In order to test a quasi butt-type join, a tensiometer was used to determine the strength of the join 24 hours after welding (the join strength increases substantially, during these 24 hours). Two test pieces of the fabric were provided after drying at 20° C. and 65% relative humidity. Each piece was 30 mm wide and 100 mm long (between the jaws of the tensiometer) with a transverse welded join as in FIG. 6. The join was parallel to and mid-way between the jaws. The jaws were moved apart at 100 mm/min. For the two test pieces, the joins broke abruptly under forces of 9.4 Kg/cm width and 8.8 Kg/cm width respectively and extensions of 74 mm (74%) and 71 mm (71%) respectively. A value of 7 Kg/cm width is considered very good for a textile seam.

### THE DRAWINGS

The invention will be further described, by way of example, with reference to the accompanying drawings, in which:

FIG. 1 is an enlarged part section of a first laminate, the thicknesses of the layers being greatly exaggerated for clarity and the correct proportions not being maintained;

FIG. 2 corresponds to FIG. 1, but shows a second laminate;

FIG. 3 is a schematic elevation showing the important steps in the fabrication of the laminate;

FIG. 4 is a schematic elevation of a plant for the continuous fabrication of the laminate;

FIG. 5a shows very schematically one way of joining two pieces of the laminate of the invention;

FIG. 5b shows the way of joining, somewhat less schematically;

FIG. 6 shows the join of FIG. 5a, with the upstand cut off;

FIG. 7 is a perspective view showing the head and blade of an ultrasonic welding machine;

FIG. 8 is a vertical section (along the plane VIII-VIII shown in FIG. 7) through the head and blades of the machine, showing schematically a welding and cutting operation of FIG. 7;

FIG. 9 is a front view of a garment made using the laminate of the invention;

FIG. 10 is the back view of the garment of FIG. 9; and

FIG. 11 is the side view of the garment of FIG. 9.

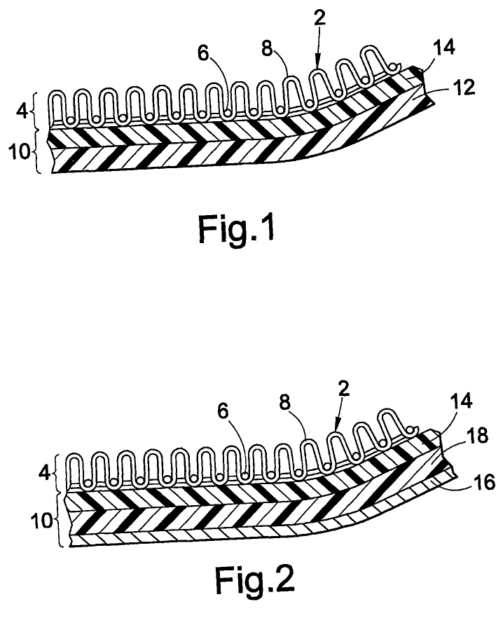

FIG. 1

A laminate 2 in accordance with the invention has a base fabric 4 illustrated in FIG. 1 which comprises a support 6 made of two types of yarn and a closed-loop pile 8 formed by a third type of yarn. To the base fabric 4 is laminated a coating 10 consisting of a skin 12 and an adhesive 14.

FIG. 2

The preferred laminate of FIG. 2 is the same as that of FIG. 1, except that the skin is in two layers, an outer layer 16 and an inner layer 18.

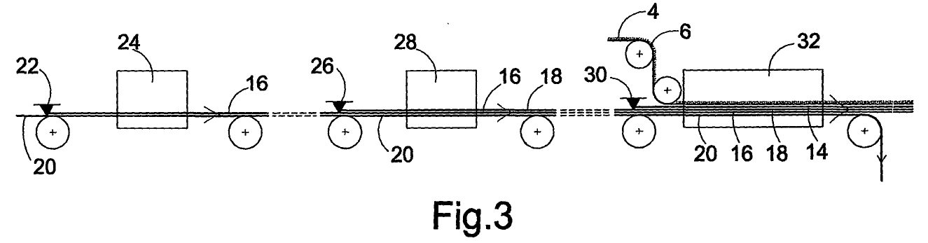

FIG. 3—General Principle of Making the Laminate

Referring to FIG. 3, a continuous support web 20 moves generally from left to right. The support web 20 is preferably a web of strong paper whose upper surface can be smooth or matt and is provided with a release coating which is non-stick (anti-adhesive) in relation to the resin later applied, for example a polypropylene or silicone coating.

At 22 a resin/solvent solution is deposited on the support web 20 which solution, after passing through an oven 24, is set (but not fully hardened) to form the outer skin layer 14. At 26 a resin/solvent solution is deposited on the skin layer 14, which solution, after passing through an oven 28, is set (but not fully hardened) to form the inner skin layer 16. At 30, a resin/solvent solution, forming the adhesive, is deposited on the inner layer 16, after which the base fabric 4 is deposited on the adhesive 12 with the pile 8 uppermost. After passing through an oven 32, the adhesive 12 is set and nearly fully hardened.

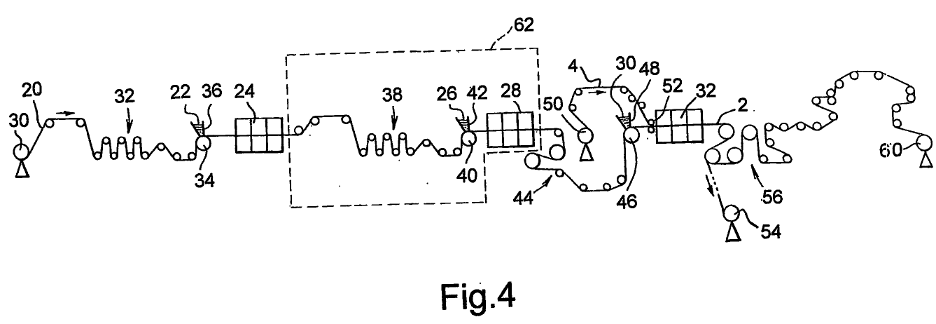

FIG. 4—One Method for Making the Laminate

The general principle illustrated in FIG. 3 can be put into practice in many different ways. FIG. 4 shows one possible plant.

The support web 20 is drawn off a reel 30 and passes through a roller accumulator 32 and around a cylinder 34 of a first coating machine (22) having a doctor blade 36. In this way, the first layer of resin (16) is applied to the support web 20. Following this, the support web 20 passes through the first tunnel oven 24, where the resin layer (16) is set (but not fully hardened) to form the outer skin layer 16.

On exiting from the first tunnel oven 24, the support web 20 with the outer skin layer 16 passes through a roller accumulator 38 and around a cylinder 40 of a second coating machine (26) having a doctor blade 42. In this way, a second layer of resin (18) is applied to the outer skin layer 16. Following this, the support web 20 passes through a second tunnel oven 28, where the resin layer (18) is set (but not fully hardened) to form the inner skin layer 18. The second tunnel oven 28 has the same dimensions and thermal characteristics as the first tunell oven 24.

On exiting from the second tunnel oven 28, the support web 20 with the skin layers 16, 18 passes through a roller arrangement 44 and then reaches a cylinder 46 forming part of a third coating machine (30) having a doctor blade 48. In this way, a layer of adhesive 14 is applied to the inner skin layer 18.

A web of the base fabric 4 is unwound from a reel 50. The base fabric 4 passes between a pair of rolls 52 the upper one of which presses the smooth side of the base fabric 4 onto the adhesive layer 14, which is still liquid. The support web 20 then passes through the third tunnel oven 32 which is three to four lines as long as the tunnel ovens 24, 28, and the solvent is evaporated and the adhesive layer 14 is nearly completely hardened and firmly adhered to the inner skin layer 18, while the meshes of the support 6 of the fabric 4 are fully adhered to the adhesive layer 14. By this time, the outer and inner skin layers 16, 18 are also nearly completely hardened. Final hardening of all layers occurs during the next 24 hours.

The composite strip which exits from the third tunnel oven 32 is now the laminate 2 as shown in FIG. 2. The support web 20 is separated from the laminate 2 and is wound on a reel 54. The laminate 2 then passes through a roller accumulator 56, and is wound on a reel 60. No finishing is required.

A dashed-outlined box 62 is shown in FIG. 4. If the skin is to be formed of a single layer, as shown in FIG. 1, the components within the box 62 are omitted.

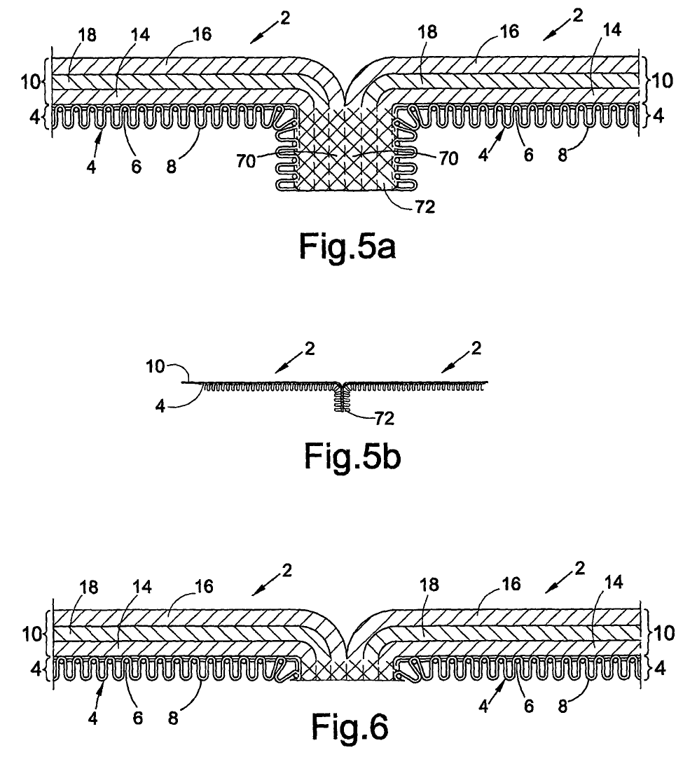

FIGS. 5a and 5b

FIG. 5a illustrates one way of joining together two portions of the laminate 2, the proportions being as in FIG. 2 (they could be (as in FIG. 1) and very schematic. The proportions in FIG. 5b are not correct but are less exaggerated. The outer skin layers 16 (i.e. the outer faces) of the edge portions 70 are brought into face-to-face contact, for instance using a roller, and welded. It is believed that at least one of the skin layers 16, 18, as well as the adhesive layer 40, melt and subsequently re-set so that the join is formed by the skin and the adhesive. If desired, the weld temperature or duration can be such that all layers except one yarn and the pile of the base fabric 42, or except just the pile of the base fabric 42, melt and the fused plastic flows into the pile of the base fabric 42, providing a very strong join, but this is not essential. The welding procedure was operated so that the upstanding seam or upstand 72 was not cut off.

FIG. 6

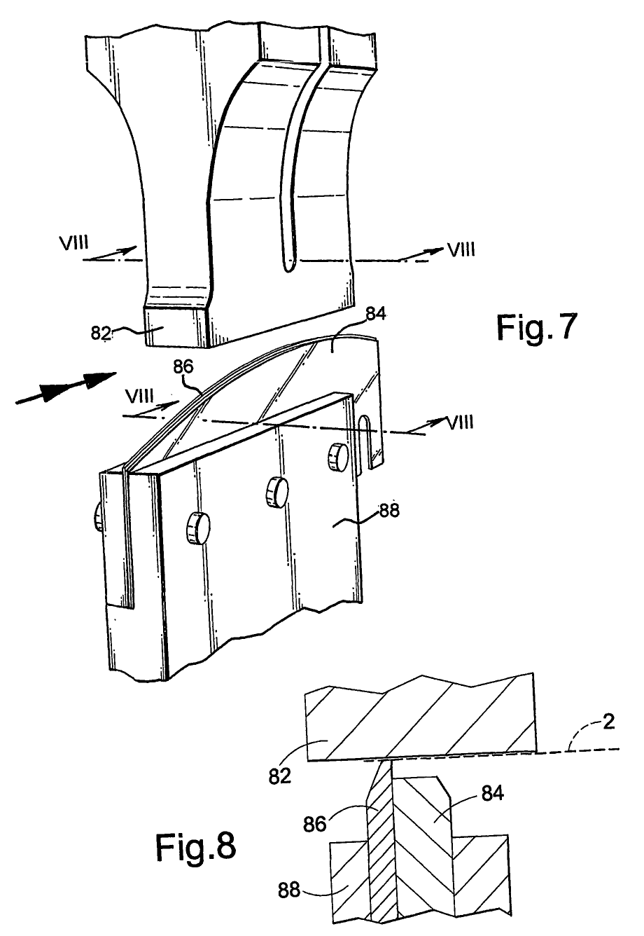

FIG. 6 is as FIGS. 5a and 5b but shows the result of using a combined ultrasonic welding and cutting procedure, for instance as described with reference to FIGS. 7 and 8, to weld and in order to trim away the upstand 72. In this way, the join can be nearly flat and not readily visible, similar to a butt join, while providing sufficient strength.

FIGS. 7 and 8

FIGS. 7 and 8 illustrate an ultrasonic welding machine. The machine has a horn 82 which is a Herrmmann MS “Sonotrode”, generally as disclosed in EP 0 790 888 A. The machine also has an anvil in the form of double blades 84, 86 which are adjustably fixed in a mount 88 which in turn can be moved up and down to alter the distance between the blades 84, 86 and the horn 82. As shown in FIG. 8, the blade 86 projects above the blade 84, and the vertical portion of the blade 86 can be adjusted. In theory, the anvil could be flat and the lower side of the horn could be contoured, but this is less convenient as the contoured part wears more quickly than the flat part and the horn is more expensive to replace than the anvil.

An experimental procedure was carried out by hand. Two layers of laminate 2 were placed face-to-face with the respective skins (outer layers 16) in contact, and held together in any suitable way, for instance by tack-welding or pinning or clipping. The horn 82 vibrates up and down at an adjustable frequency and with an adjustable amplitude. When the horn 82 is in its upper position, the two layers 2 can pass between the tip of the blade 65 and the horn 82 without frictional resistance. The layers 2 are fed by hand in the direction of the double arrow shown in FIG. 7, and the speed is controlled to obtain suitable welding. The slower the speed, the hotter the welding. The width of the weld is determined by the width of the blade 84 and can be for instance 1 mm, 2 mm or 3 mm. The blade 86 cuts or trims off the selvages, to produce a join which will be generally as in FIG. 6 when the layers 2 are opened up. The welding temperature within the pieces of laminate 2 is not known, but may be in the range of 170° to 240° C.

If the outer skin layer 16 has a higher melting point than the inner skin layer 18, the position of the horn 82 must be adjusted so that when it is in its lowermost position during vibration, it puts pressure on the laminate 2 so that the layer 16 plastifies or melts and moves aside out of the welding zone. To do this, the difference in heights between the blades 84, 86 must be such as to allow the blade 84 to apply pressure to the laminate (as shown), or alternatively the blades may have to be adjusted to the same height and the cut-off occur later.

In the experimental procedure, suitable parameters were found to be:

total width of blade 84 plus blade 86: 2mm

frequency: 35 kHz

amplitude (bottom of horn 62); greater than 30 μm

gap between blade 64 and horn 62 at lowermost position of horn 62: 297.5 μm

gap between blade 65 and horn 62 at lowermost position of horn 62: 0 to 0.5 μm

In production, a feed can be used with digital control of the x direction (the double arrow in FIG. 7) and the y direction (horizontally at right angles to the arrow).

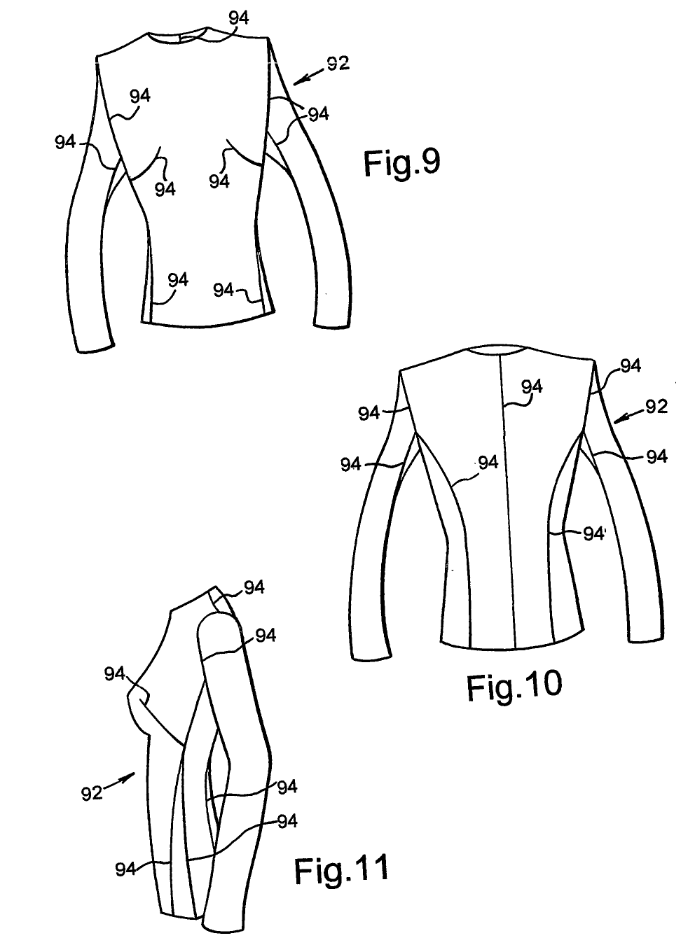

FIGS. 9 to 11

These Figures illustrate a garment 92 made up using shaped pieces of the laminate according to the invention, welded together. The lines 94 within the outline of the garment indicate the joins.

### EXAMPLE

The Base Fabric—Formation

The base fabric was knitted on a circular knitting machine with a fineness of 18 flat needles per inch and providing a circular fabric of a nominal circumference of 200 cms. Due to the elasticity of the support of the fabric, the fabric shrinks to provide a flat double-thickness strip of a maximum width of 85 cms.

The knit of the base fabric is a terry cloth (closed-loop knitted fabric) made as set out by way of example in the following table, which has three columns, the left-hand one of which gives the number of the order of the picks, from 1 to 4, picks 1 to 4 being repeated, and the middle one of which gives the type of base yarn (PES=polyester, ELA=elastic yarn), as well as the twist S or Z of the polyester; as indicated in the right-hand column, the closed-loop pile is cotton (COT=cotton).

| Pick | Support | Pile |
|---|---|---|
| 1 | PES Z | COT |
| 2 | ELA | COT |
| 3 | PES S | COT |
| 4 | ELS | COT |

In this procedure, the machine was regulated in order to have the following lengths of yarn utilisation (LFA):

Base: 34 cms/100 needles;

Pile: 64.9 cms/100 needles.

The Base Fabric—Components

The base fabric had a support formed of an effectively non-elastic polyester yarn and an elastic yarn, with a closed-loop pile formed by a cotton yarn.

The non-elastic yarn was:

“Dacron” terephthalate polyester yarn as supplied by DuPont De Nemours, containing 85% by weight of a diol-terephthalic acid ester;

yarn count: 780 Km/Kg (initially 84 dtex, at point of use 78 dtex);

twisted (the picks are with alternate S and Z twist);

melting point: 240° C;

elongation at break: 22%;

shrinkage: 5.6%, according to DIN EN 150 53585T3.

The elastic yarn was:

“Elastane”, supplied by DuPont De Nemours, having a polyurethane core with a polyester wrap (by weight, 32.25% polyurethane, 67.75% polyamide);

yarn count: initially 37 dtex, at point of use 34 dtex;

elongation at break: 600%;

core melting point: 90° C.;

wrap melting point: 90° C.;

The cotton was:

combed unfinished substantially pure blended cotton;

one end twisted 1/50, metric;

grade/weight: 50000 m/Kg;

decomposition temperature: 160° C.

The base fabric so knitted had the following characteristics:

thickness of support—about 0.3 mm;

height of pile—1.5 to 1.7 mm;

weight—280 to 295 g/m².

The Skin

“VITHANE 319” was used to form the outer skin layer 16. The product is a 34 to 36% by weight solution of a solid non-volatile aromatic one-component polyurethane in dimethyl formamide, with no plasticiser. The solution has a Brookfield viscosity at 25° C. % of 35 to 50 Pa·s. The fully hardened polyurethane had a melting point of 230° C. and an elongation at break of 700%. The polyurethane is not a hydrophilic resin.

“VITHANE TR 7030”, was used to form inner skin layer 18. The product is a 29 to 31% by weight solution of a solid non-volatile aromatic one-component polyurethane dissolved in formamide, with no plasticiser. The solution had a Brookfield viscosity at 25° C. of 50 to 80 Pa·s. The fully hardened polyurethane had a melting point of 190° C. and an elongation at break of 920%. The polyurethane is a transpiring (breathable), hydrophilic resin.

The Adhesive

“VITHANE TR 7050” with additives was used to make the adhesive. The product is a 43 to 45% by weight solution of a solid non-volatile aromatic one-component polyurethane, dissolved in dimethyl formamide, with no plasticiser. The additives were:

1% by weight of “VITHANE C2”, a modified melamine resin, being an 80% by weight solution in isobutyl alcohol. The solution has a Brookfield viscosity at 25° C. of about 3.5 Pa.

2% by weight of “VITHANE A6”, a 10% by weight solution of an amine salt of p-toluene sulphonic acid in dimethyl formamide, the salt acting as a catalyst for the “VITHANE C2”.

The solution had a Brookfield viscosity at 25° C. of 50 to 80 Pa·s. The fully hardened adhesive had a melting point of 210° C. and an elongation at break of 230%. The adhesive is a transpiring, hydrophilic resin.

The Method of Lamination

The method was as in FIG. 3. In each tunnel oven 24, 28, 32, the temperature was of the order of 150° C., that is above the evaporation temperature of the resin solvent, to cause the adhesive to set. The skin layers 16, 18 had at least partially hardened on leaving the respective tunnel ovens 24, 28 and the skin layers 16, 18 and adhesive layer 14 had nearly fully hardened on leaving the tunnel oven 32 (and were fully hard after 24 hours). In a preferred arrangement, the velocity of the support 20 was 15 m/min and the tunnel ovens 24, 28, 32 had respective lengths of 4 metres, 4 metres and 12 metres.

The Laminate

The laminate set out above was as follows:

Base fabric—by weight, 84% cotton, 7.5% “Elastane”, 8.5% polyester

Base fabric—280 to 295 g/m² (as above)

Outer skin layer 16—about 35 g/m²

Inner skin layer 18—about 25 g/m²

Adhesive layer 14—about 30 g/m²

Coating 10 (layers 16, 18 and 14)—93 g/m²

Thickness of coating 10—about 15 to 20 microns.

Laminate—by weight, 79% cotton, 7% “Elastane”, 8.1% polyester, 5.9% polyurethane.

It is found that the adhesive layer 14 engages the base fabric 4 at spaced points across the whole face of the base fabric 4. If the non-stick surface of the support web 20 is smooth, the visible side of the laminate 2, i.e. the outer skin layer 16, is also smooth.

The laminate had good transpirability. The laminate had a high resistance to water penetration and was effectively impermeable to water.

On testing after 24 hours (during which the weld strength increases), it was found that the strength of the weld was not lower than the strength of the adhesive of the base fabric to the skin, indicating a high strength weld.

An alternative to VITHANE 319” referred to above is “UCECOAT TCM 35”, supplied by UCB Chemicals. The product is in an approximately 35% by weight solution of an aromatic one-component polyester based polyurethane in dimethyl formamide. The solution has a Brookfield viscosity at 25° C. of approximately 48 Pa·s. The fully hardened resin had a softening range of 180° C. to 190° C. with a melting point of 190° C., and an elongation at break of 550%.

Further experimental work is being done with outer skin layers formed of polyurethanes having melting points of 180° C. and down to 150° C.

In a different laminate, the outer and inner skin layers 16, 18 referred to above can be reversed, the outer skin layer thus having the lower melting point.

In the above text, various commercial designations are given for the products used. Unless otherwise indicated, the products are as on Aug. 1, 2001. All the “VITHANE” products are supplied by Rohm & Haas Italia s.r.l.

Unless the context clearly requires otherwise, throughout the description and the claims, the words ‘comprise’, ‘comprising’, and the like, are to be construed in an inclusive as opposed to an exclusive or exhaustive sense; that is to say, in the sense of “including, but not limited to”.

The present invention has been described above purely by way of example, and modifications can be made within the spirit of the invention.

1. A process for making an article, comprising using a stretchable synthetic adhesive to laminate a stretchable synthetic skin to a base fabric which is elastically stretchable in two directions at right angles in the plane of the base fabric, whereby the laminate is elastically stretchable in two directions at right angles in the plane of the laminate, the skin and the layer of adhesive together being substantially impermeable to water but permeable to water vapour, whereby the laminate is substantially impermeable to water but permeable to water vapour, and making the article by making joins between portions of the laminate by a welding procedure.

2. The process according to claim 1, and comprising:
depositing on a non-stick support at least a first liquid layer of resin;
setting the first liquid layer, to form the skin;
depositing on the skin a second layer of a liquid resin having adhesive properties;
applying the base fabric to the second liquid layer;
setting the second liquid layer; and
removing the substrate from the skin.

3. The process according to claim 2, carried out continuously, the support being in the form of a web and the base fabric being in the form of a web, the first layer of liquid resin being applied to the support which is then passed into a tunnel heater to evaporate solvent from the resin and set the first layer to form the skin, the second layer of liquid resin being applied to the skin, and the base fabric being applied to the second layer while the resin of the second layer is still liquid, after which the base fabric together with the skin and the second layer of resin are passed through a second tunnel heater to evaporate the resin solvent and set the second layer.

4. The process according to claim 2 or 3, wherein said support comprises paper having a non-stick layer on its face which receives said first layer.

5. The process according to claim 1, wherein the adhesive is applied to the skin and the base fabric is then pressed against the adhesive.

6. A process for making an article, comprising providing a laminate formed of a base fabric which is elastically stretchable in two directions at right angles to the plane of the base fabric and on to which a stretchable synthetic skin has been laminated by means of a stretchable synthetic adhesive, whereby the laminate is elastically stretchable in two directions at right angles in the plane of the laminate, the skin and the layer of adhesive together being substantially impermeable to water but permeable to water vapour, whereby the laminate is substantially impermeable to water but permeable to water vapour, and making the article by making joins between portions of the laminate by a welding procedure.

7. The process according to any of the preceding claims, wherein the welding is ultrasonic.

8. The process of any of the preceding claims, wherein portions of the laminate are placed face-to-face with the respective skins in contact, and a join is made between the portions by the welding procedure.

9. The process according to claim 8, wherein substantially all of the edge zones of the portions are cut away.

10. The process of claim 9, wherein the welding and cutting are effected substantially simultaneously.

11. The process according to any of the preceding claims, wherein at least one layer of the skin and the adhesive melt and re-set during the welding procedure.

12. The process according to any of the preceding claims, wherein the base fabric comprises at least one yarn which does not melt or degrade during the welding procedure.

13. The process according to any of the preceding claims, wherein the base fabric comprises at least one yarn which melts and re-sets during the welding procedure.

14. The process according to any of the preceding claims, wherein the base fabric has a pile.

15. The process according to claim 14, wherein the pile is formed of a yarn which does not melt or degrade during the welding procedure.

16. The process according to claim 14 or 15, wherein the base fabric is a terry cloth.

17. The process according to claim 14 or 15, wherein the pile is a closed-loop pile.

18. The process according to any of claims 14 to 17, wherein the pile is formed by a yarn different from the yarn or yarns forming the support of the base fabric.

19. The process according to any of claims 14 to 18, wherein the yarn of the pile is substantially pure cotton.

20. The process according to any of the preceding claims, wherein the base fabric or its support comprises two yarns, one of which is substantially inextensible and the other of which is elastic.

21. The process according to claim 20, wherein the elastic yarn has an elastic core with another yarn wrapped around it.

22. The process according to claim 21, wherein the elastic yarn is of nylon with a polyester wrap.

23. The process according of any of the preceding claims, wherein the base fabric is knitted.

24. The process of any of the preceding claims, wherein the skin is formed of at least an outer layer and an inner layer of different composition.

25. The process of claim 24, wherein the outer skin layer is not hydrophilic and the inner layer is hydrophilic.

26. The process of claim 24 or 25, wherein the outer skin layer has a higher melting point than the inner skin layer.

27. The process of claim 24 or 25, wherein the outer skin layer has a lower melting point than the inner skin layer.

28. The process of claim 24 or 25, wherein the outer skin layer has substantially the same melting point as the inner skin layer.

29. The process of claim 27 or 28, wherein the outer skin layer has substantially the same melting point as the adhesive or has a lower melting point than the adhesive.

30. The process of any of the preceding claims, wherein the skin or at least one layer thereof is formed of polyurethane.

31. The process of claim 30, wherein the skin or at least one layer thereof is formed of one-component polyurethane.

32. The process of claim 30 or 31, wherein the polyurethane of the skin contains no plasticiser.

33. The process according to any of claims 30 to 32, wherein polyurethane of the skin is aromatic.

34. The process according to any of claims 1 to 23, wherein the skin comprises “VITIANE TR 7030”, or the like.

35. The process according to any claims 1to 23, wherein the skin comprises “UCECOAT TCM 35”, or the like.

36. The process according to claim 24, wherein the outer skin is formed of “VITHANE 319”,or the like.

37. The process according to claim 24, wherein the outer skin is formed of “USECOAT TCM35”, or the like.

38. The process according to any claims 24, 36 or 37, wherein the inner skin layer is formed of “VITHANE TR 7030, or the like.

39. The process according to any of the preceding claims, wherein the adhesive comprises polyurethane.

40. The process according to claim 39, wherein the adhesive comprises a one-component polyurethane.

41. The process according to claim 39 or 40, wherein the adhesive comprises an aromatic polyurethane.

42. The process according to any of the preceding claims, wherein the adhesive contains no plasticiser.

43. The process according to any of the preceding claims, wherein the adhesive comprises a mixture of resins.

44. The process according to claim 43 and also to any of claims 39 to 42, wherein the adhesive as applied comprises a urethane precusor and or melamine precusor.

45. The process according to any of claims 1 to 38, wherein the adhesive comprises of “VITHANE TR 7050”, or the like.

46. The process according to any of claims 1 to 38, wherein the adhesive is formed of “VITHANE TR 7050”, or the like, plus one or more additives.

47. The process according to claim 46, wherein the additives are “VITHANE C2” and “VITHANE A6”, or the like.

48. The process according to any of the preceding claims, wherein the skin and the adhesive comprise hydrophilic transpiring polyurethanes, thereby making the laminate substantially impermeable to water and permeable to water vapour.

49. A made-up article made by the process of any of the preceding claims.

50. A laminate suitable for the welding procedure of any of claims 1 to 48, the laminate comprising a base fabric which is elastically stretchable in two directions at right angles in the plane of the base fabric, and a stretchable synthetic skin laminated to the base fabric by a stretchable synthetic adhesive, whereby the laminate is elastically stretchable in two directions at right angles in the plane of the laminate, the skin and the layer of adhesive together being substantially impermeable to water but permeable to water vapour, whereby the laminate is substantially impermeable to water but permeable to water vapour, the skin being such as to melt during the welding procedure and the base fabric comprising a yarn which does not melt or degrade during the welding procedure.

51. A process for making a laminate, substantially as herein described with reference to FIG. 3, or FIGS. 3 and 4, of the accompanying drawings.

52. A laminate, substantially as herein described with reference to FIG. 1 or FIG. 2 or FIG. 3 or FIG. 4 of the accompanying drawings.

53. A process for making a made-up article, substantially as herein described with reference to FIGS. 5a and 5b, or FIG. 6, of the accompanying drawings.

54. A process for making a made-up article, substantially as herein described with reference to FIGS. 7 and 8 of the accompanying drawings.

55. A made-up article substantially as herein described with reference to FIGS. 9 to 11 of the accompanying drawings.
